(19) United States
(12) Patent Application Publication
(10) Pub. No.: US 2016/0293050 A1
(43) Pub. Date: Oct. 6, 2016

(54) BRAILLE READING APPARATUS

(71) Applicant: Boe Technology Group Co., Ltd., Beijing (CN)

(72) Inventors: Hao Wang, Beijing (CN); Li Sun, Beijing (CN)

(21) Appl. No.: 14/741,702

(22) Filed: Jun. 17, 2015

(30) Foreign Application Priority Data
Mar. 30, 2015 (CN) 201510144469.7

(51) Int. Cl. G09B 21/00

(52) U.S. Cl. CPC G09B 21/004

(57) ABSTRACT

The present disclosure discloses a Braille reading apparatus comprising a housing forming a cavity that envelops gas, wherein the housing is provided with at least one air hole at the surface of one side, a valve layer being arranged between the air hole and the cavity for control of the outflow of the gas. The Braille reading apparatus can effectively address the problem of existing Braille representing approaches that the paper cannot be recycled and thus a severe waste of resource is caused.

### RELATED APPLICATIONS

The present application claims the benefit of Chinese Patent Application No. 201510144469.7, filed Mar. 30, 2015, the entire disclosure of which is incorporated herein by reference.

### FILED OF THE DISCLOSURE

The disclosure relates to the technical field of special reading devices, and particularly to a Braille reading apparatus.

### BACKGROUND OF THE DISCLOSURE

The visually impaired read mainly via Braille. A standard Braille character is formed by a dot matrix of 3*2 dots, with presence or absence of bumps at different dots representing different meanings. The representation of Braille characters requires control of presence of bumps at different dots.

The traditional Braille is typically implemented by fabricating symbols of bumps on a piece of paper. Due to destruction of the paper, it is difficult in the prior art to recycle the same piece of paper to fabricate symbols of bumps, thereby resulting in a severe waste of resource.

### SUMMARY OF THE DISCLOSURE

In view of the problem that the paper cannot be recycled in the existing Braille representing approach, which results in a severe waste of resource, it is an object of the present disclosure to provide a Braille reading apparatus.

In an embodiment of the present disclosure, there is provided a Braille reading apparatus comprising a housing forming a cavity that envelops gas, wherein the housing is provided with at least one air hole at the surface of one side, a valve layer being arranged between the air hole and the cavity for control of the outflow of the gas.

Optionally, the cavity layer comprises at least one air passage corresponding to the at least one air hole, each air passage comprising an air passage valve and an air passage pathway.

Optionally, the Braille reading apparatus further comprises a control unit. The control unit is electrically connected with the valve layer for control of the opening and closing of the individual air passage valves in the valve layer based on the information to be read.

Optionally, the Braille reading apparatus further comprises a receiving unit. The receiving unit is electrically connected with the control unit for input of the received information to be read to the control unit.

Optionally, the Braille reading apparatus further comprises an air pump. The air pump is gaseously connected with the cavity.

Optionally, a Braille character is formed by a dot matrix of air holes. Optionally, the Braille reading apparatus further comprises an input component for providing to the control unit an indication of scrolling the outputted Braille characters.

Optionally, the input component is selected from a group consists of a key, a scroll wheel, a trackball, and a touch screen.

The Braille reading apparatus according to the embodiments of the present disclosure is able to represent any desired Braille characters in a configurable manner, thereby effectively addressing the problem of paper waste that is caused by the existing Braille representing approach. Furthermore, application of the high-pressure gas in aiding the tactility is advantageous in that the high-pressure gas is easily available and low in cost, compared to other material on the market.

### BRIEF DESCRIPTION OF THE DRAWINGS

Further details, features and advantages of the disclosure are disclosed in the following description of exemplary embodiments in connection with the accompanying drawings, in which:

FIG. 1 is a structural schematic diagram of a Braille reading apparatus provided by an embodiment of the present disclosure; and

FIG. 2 is a structural schematic diagram of the valve layer of a Braille reading apparatus provided by an embodiment of the present disclosure.

### REFERENCE NUMERALS

1—housing, 2—cavity, 3—air hole, 4—valve layer, 5—air passage, 6—air passage valve, 7—air passage pathway, 8—air pump

### DETAILED DESCRIPTION OF THE DISCLOSURE

To make the objects, technical solutions and advantages of the present disclosure more clear, the embodiments of the present disclosure will be further described in detail in combination with the accompanying drawings.

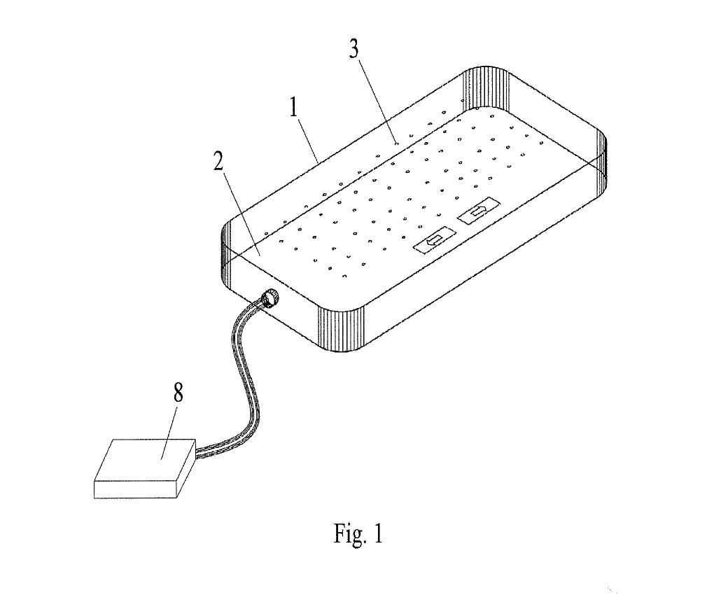

FIG. 1 is a structural schematic diagram of a Braille reading apparatus provided by an embodiment of the present disclosure. As is shown in the figure, the Braille reading apparatus comprises a housing 1 forming a cavity 2 that envelops gas. The housing 1 is provided with at least one air hole 3 at the surface of one side. A valve layer (discussed below) is arranged between the at least one air hole 3 and the cavity 2. A Braille character may be formed by a dot matrix of (e.g. 3*2) air holes 3. The gas creates a similar tactility to that of a bump at the fingertip of a user after being ejected from an air hole 3 in a dot matrix, such that the Braille character represented by the dot matrix can be perceived by the user, thereby achieving an identification of the Braille character.

To ensure that the gas flowing out of the air holes 3 is of a sufficient high pressure so as to enhance the identifiability of the Braille characters, as is shown in FIG. 1, the Braille reading apparatus further comprises an air pump 8. The air pump 8 is gaseously connected with the cavity 2 for pumping high-pressure gas into the cavity 2. It is to be understood that the gas flowing out of the air holes 3 is “high-pressure” to the extent that it can create a sufficient pressure at the fingertip of a user to be perceived by the user. In this way, the Braille characters may be identified by the user more easily. Additionally, the surface of the housing 1 on which the at least one air hole 3 is provided is illustrated in FIG. 1 as being of a rounded rectangle shape, although other shapes are possible.

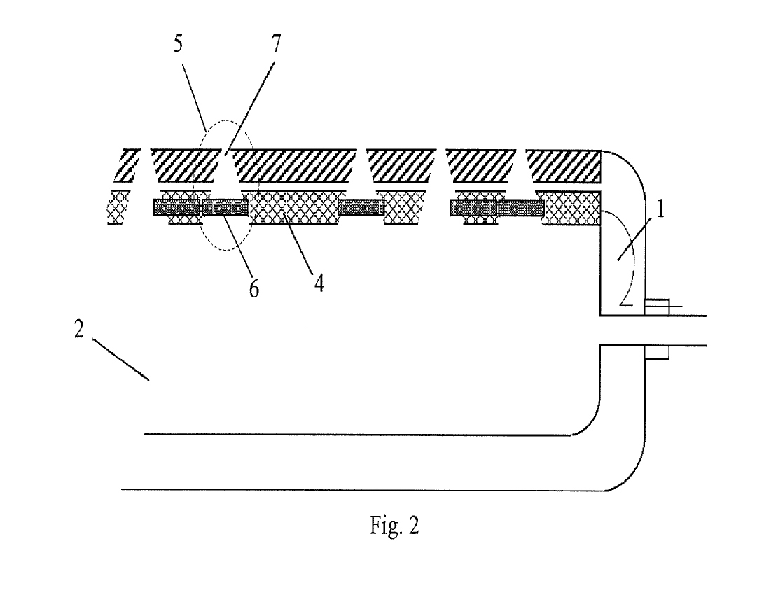

FIG. 2 is a structural schematic diagram of the valve layer 4 of a Braille reading apparatus provided by an embodiment of the present disclosure. As is shown in the figure, the valve layer 4 may comprise at least one air passage 5 corresponding to the air holes 3, each of which may further comprise an air passage valve 6 and an air passage pathway 7. Each of the air passage pathways 7 corresponds to one character dot, and the air passage valve 6 controls the opening and closing of its respective air passage pathway 7. The opened or closed state of the air passage pathway 7 determines whether there is high-pressure gas flowing out of the air hole 3 corresponding thereto. When the air passage valve 6 is at a first position, the air passage pathway 7 is closed such that there is no gas flowing out of the air hole 3. When the air passage valve 6 is at a second position, the air passage pathway 7 is opened such that the gas in the cavity 2 flows out of the air hole 3. Such valve control mechanism is known in the art, and is not discussed here in detail.

The Braille reading apparatus provided by the embodiment of the present disclosure may further comprise a control unit (not shown). The control unit may be electrically connected with the valve layer 4 for control of the opening and closing of the individual air passage valves 6 in the valve layer 4 based on the information to be read. Additionally, the Braille reading apparatus may further comprise a receiving unit (not shown). The receiving unit may be electrically connected with the control unit for input of the received information to be read to the control unit.

It should be understood that said “information to be read” may be control information that is used for direct control of the opening and closing of the air passage valves, or it may be original text and/or graphical information. In the latter case, the control unit can convert the original text and/or graphical information into control information that is used for control of the opening and closing of the air passage valves. For example, depending on the number of the Braille characters that can be accommodated in each line of the Braille reading apparatus, the control unit performs segmentation of the text to be read into several segments for adaption to the number of the Braille characters in each line, and converts the original characters in each segments into the Braille characters corresponding thereto and in turn, generates control information that is used for control of the opening and closing of the air passage valves based on the dot pattern of the Braille characters.

In practical use, the information to be read often extends that which can be conveyed by the Braille characters in one page of the Braille reading apparatus. In this case, the control unit may scroll the Braille characters that are represented on the Braille reading apparatus to a specific segment to be read.

To this end, an input component can be arranged on the Braille reading apparatus for providing to the control unit an indication of scrolling the outputted Braille characters. By way of example, the input component may be an up arrow key and a down arrow key on the Braille reading apparatus as illustrated in FIG. 1. The arrow keys are illustrated in FIG. 1 as two separate keys, although combination of which into one is possible. In an implementation, such input component may be a physical key or other physical input mechanism (e.g. a scroll wheel, a trackball, etc.) for ease of use by the blind users. In another implementation, such input component may be a tactile input mechanism based on a touch screen, such as a touch pad. In this way, providing an output controllability (e.g. scrolling up, scrolling down, paging, etc.) over the Braille segments brings improved experience to the user.

It should be understood by the skilled in the art that the various illustrative modules and circuits (e.g. the control unit) described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

Therefore, it is to be understood that the embodiments of the disclosure are not to be limited to the specific embodiments disclosed and that modifications and other embodiments are intended to be included within the scope of the appended claims. Although specific terms are used herein, they are used in a generic and descriptive sense only and not for purposes of limitation.

1. A Braille reading apparatus, comprising:
a housing forming a cavity that envelops gas;
wherein the housing is provided with at least one air hole at the surface of one side, a valve layer being arranged between the air hole and the cavity for control of the outflow of the gas.

2. The Braille reading apparatus of claim 1, wherein the cavity layer comprises at least one air passage corresponding to the at least one air hole, each air passage comprising an air passage valve and an air passage pathway.

3. The Braille reading apparatus of claim 2, further comprising a control unit that is electrically connected with the valve layer for control of the opening and closing of the individual air passage valves in the valve layer based on the information to be read.

4. The Braille reading apparatus of claim 3, further comprising a receiving unit that is electrically connected with the control unit for input of the received information to be read to the control unit.

5. The Braille reading apparatus of claim 1, further comprising an air pump that is gaseously connected with the cavity.

6. The Braille reading apparatus of claim 1, wherein a Braille character is formed by a dot matrix of air holes.

7. The Braille reading apparatus of claim 3, further comprising an input component for providing to the control unit an indication of scrolling the outputted Braille characters.

8. The Braille reading apparatus of claim 7, wherein the input component is selected from a group consisting of a key, a scroll wheel, a trackball, and a touch screen.
